(19) United States
(12) Patent Application Publication
(10) Pub. No.: US 2006/0294271 A1
(43) Pub. Date: Dec. 28, 2006

(54) Interface device and storage device

(75) Inventor: Yuuko Maki, Iruma-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/448,823

(22) Filed: Jun. 8, 2006

(30) Foreign Application Priority Data
Jun. 27, 2005 (JP) 2005-186948

(51) Int. Cl. G06F 13/38

(52) U.S. Cl. 710/62

(57) ABSTRACT

According to one embodiment, an interface device, which is configured to be mountable in a storage device, includes a first serial interface which executes communication with a host, a second serial interface which executes communication with an external device, a unit which calculates a total storage capacity by adding a storage capacity of the storage device to a storage capacity of the external device, and informs the host of the total storage capacity, an address decoder which determines whether an address value included in an access command from the host belongs to address range which is to be assigned to the storage device, and a unit which sends an access command to a data storage unit within the storage device if the address value belongs to the address range, and transmits the access command to the external device if the address value does not belong to the address range.

### CROSS-REFERENCE TO RELATED APPLICATIONS

This application is based upon and claims the benefit of priority from Japanese Patent Application No. 2005-186948, filed Jun. 27, 2005, the entire contents of which are incorporated herein by reference.

### BACKGROUND

1. Field

One embodiment of the invention relates to an interface device which controls communication with a host apparatus via a serial interface, and a storage device including the interface device.

2. Description of the Related Art

In recent years, various storage systems have been developed.

Jpn. Pat. Appln. KOKAI Publication No. 8-16320 discloses a disk sub-system including an n-number of disk drives. In the disk sub-system, an intermediate control device and the n-number of disk drives are daisy-chained by control information signal lines.

In addition, Jpn. Pat. Appln. KOKAI Publication No. 10-269024 discloses a disk array including a plurality of hard disk drives which are daisy-chained via a Small Computer System Interface (SCSI).

In recent years, devices having serial interfaces, which support the serial-ATA (ATA: AT Attachment) standard, have been developed. In the conventional parallel-ATA (ATA: AT Attachment) standard, a parallel bus (parallel bus) including many signal lines is used. By contrast, a serial bus (serial cable) is used in the serial-ATA standard.

The device having the serial interface, which supports the serial-ATA standard, is connected point-to-point to the host apparatus via the serial bus. Thus, the number of devices, which are connectable to the host apparatus, is equal to the number of serial interfaces which are provided in the host apparatus.

In addition, if the number of serial interfaces, which are provided in the host apparatus, is only one, the number of devices, which are connectable to the host apparatus, is limited to only one.

It is thus necessary to realize a novel function for making it possible for a host apparatus to access a plurality of devices via one serial interface even if the number of serial interfaces, which are provided in the host apparatus, is only one. Thereby, the addition of a device, such as a hard disk drive, can easily be realized.

In this case, however, it is necessary to avoid alteration of interface specifications relating to the communication with the host apparatus in order to maintain compatibility with the serial-ATA standard.

As mentioned above, in the serial-ATA standard, it is assumed that the host apparatus and the device are connected point-to-point via the serial bus. It is thus necessary to provide such a scheme that the number of devices, which are connected to the serial interface of the host apparatus, is always recognized as being one from the side of the host apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of a system including storage devices on which interface devices according to an embodiment of the invention are provided;

FIG. 2 is an exemplary flow chart illustrating an operation which is executed by the interface device according to the embodiment at the time of power-on;

FIG. 3 is an exemplary flow chart illustrating an operation which is executed by the interface device according to the embodiment in response to an IDENTIFY DEVICE command from a host;

FIG. 4 is an exemplary flow chart illustrating an operation which is executed by the interface device according to the embodiment in response to an access command from the host;

FIG. 5 illustrates an operation which is executed in the system shown in FIG. 1 in response to the IDENTIFY DEVICE command;

FIG. 6 shows an example of address map information which is used in the system shown in FIG. 1;

FIG. 7 shows a modification of the system shown in FIG. 1; and

FIG. 8 is an exemplary block diagram showing another configuration of the interface device according to the embodiment.

### DETAILED DESCRIPTION

Various embodiments according to the invention will be described hereinafter with reference to the accompanying drawings. In general, according to one embodiment of the invention, an interface device which is configured to be mountable in a storage device and controls communication between the storage device and a host apparatus, includes: a first serial interface which executes communication with the host apparatus; a second serial interface which executes communication with an external device; a storage capacity notification unit which calculates a total storage capacity by adding a storage capacity of the storage device to a storage capacity of the external device, which is informed from the external device via the second serial interface, and informs the host apparatus of the total storage capacity via the first serial interface; an address map storing unit which stores address map information indicative of an address range which is to be assigned to the storage device, the address map information being calculated based on a relationship between the total storage capacity and the storage capacity of the storage device; an address decoder which determines, in a case where an access command that is sent from the host apparatus is received by the first serial interface, whether an address value included in the access command belongs to the address range based on the address value included in the access command and the address map information; and a control unit which sends the access command to a data storage unit within the storage device in a case where the address value belongs to the address range, and transmits the access command to the external device via the second serial interface in a case where the address value does not belong to the address range.

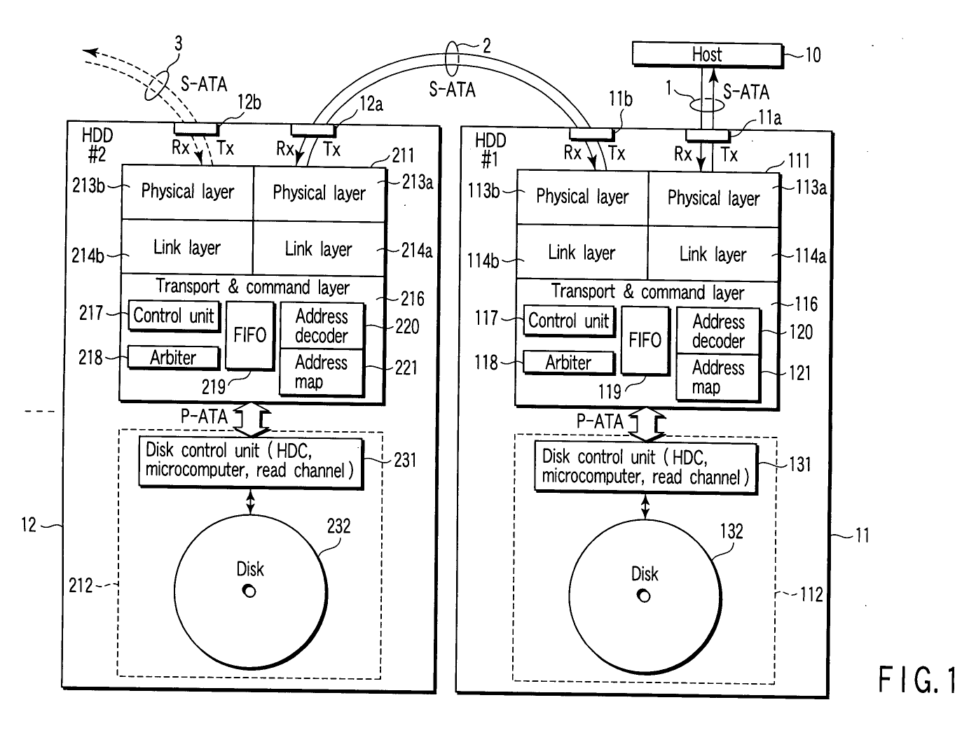

FIG. 1 shows a configuration of a system including a plurality of storage devices on which interface devices according to an embodiment of the invention are provided.

This system functions, for example, as a computer, a video recorder, etc. This system comprises a host apparatus 10 and a plurality of hard disk drives 11, 12, . . . . The hard disk drives 11, 12, . . . , are daisy-chained by some serial buses which support the serial-ATA (hereinafter “S-ATA”) standard.

The first hard disk drive (HDD #1) 11 is a storage device which stores data, and has two serial ports 11a and 11b. The serial port 11a is a connector for connection to a host apparatus, that is, an upstream-side device of the daisy chain. The serial port 11b is a connector for connection to an external device, that is, to a downstream-side device of the daisy chain.

Similarly, the second hard disk drive (HDD #2) 12 is a storage device which stores data, and has two serial ports 12a and 12b. The serial port 12a is a connector for connection to an upstream-side device of the daisy chain. The serial port 12b is a connector for connection to a downstream-side device of the daisy chain.

The serial port 11a of the first hard disk drive (HDD #1) 11 is connected to the host apparatus 10 via a serial bus (serial cable) 1 which supports the S-ATA standard. The serial bus 1 includes two pairs of differential signal lines. One of the differential signal line pairs is used for data transmission from the first hard disk drive (HDD #1) 11 to the host apparatus 10, and the other is used for data transmission from the host apparatus 10 to the first hard disk drive (HDD #1) 11.

The host apparatus 10 is constituted by a host controller which is provided in a computer body or a video recorder body. The host controller is a controller which supports the S-ATA standard. The host controller controls the storage device which is connected to the serial bus 1.

The serial port 11b of the first hard disk drive (HDD #1) is connected to the serial port 12a of the second hard disk drive (HDD #2) 12 via a serial bus (serial cable) 2 which supports the S-ATA standard. The serial bus 2, too, includes two pairs of differential signal lines. One of the differential signal line pairs is used for data transmission from the second hard disk drive (HDD #2) 12 to the first hard disk (HDD #1) 11, and the other is used for data transmission from the first hard disk drive (HDD #1) 11 to the second hard disk drive (HDD #2) 12.

The serial port 12b of the second hard disk drive (HDD #2) 12 is connected, as needed, to a serial port of a third hard disk drive (not shown) via a serial bus (serial cable) 3 which supports the S-ATA standard. A hard disk drive, which is connected at a terminal end of the daisy chain, does not necessarily have two serial ports. In other words, the terminal-end hard disk drive may be an ordinary device having a single serial port which supports the S-ATA standard.

From the second hard disk drive (HDD #2) 12 side, the first hard disk drive (HDD #1) 11 is recognized as a host apparatus for the second hard disk drive (HDD #2) 12. Similarly, from the third hard disk drive side, the second hard disk drive (HDD #2) 12 is recognized as a host apparatus for the third hard disk drive.

The first hard disk drive (HDD #1) 11 comprises an interface device 111 and a data storage unit 112.

The interface device 111 is a device which is mounted in the first hard disk drive (HDD #) 11 in order to control serial communication via the two serial ports 11a and 11b. For example, the interface device 111 is realized by a single LSI. The interface device 111 is connected to the two serial ports 11a and 11b. The interface is also connected to the data storage unit 112 via an internal bus according to the parallel-ATA (P-ATA) standard.

The interface device 111 has a function of controlling the communication between the data storage unit 112 and host apparatus 10, and a function of controlling the communication with the second hard disk drive (HDD #2) 12.

An interface device, which is mounted in an ordinary hard disk drive having one serial port that supports the S-ATA standard, is configured to include a physical layer unit, a link layer unit, a transport layer unit and a command layer unit in the named order from the serial port side. In the present embodiment, since the first hard disk drive (HDD #1) 11 includes the two serial ports 11a and 11b, the interface device 111 includes a physical layer unit and a link layer unit in association with each of the serial ports.

Specifically, the interface device 111 includes two physical layer units 113a and 113b, two link layer units 114a and 114b, and a transport layer & command layer unit 116.

The physical layer unit 113a and link layer unit 114a function as a first serial interface which executes serial communication with the host apparatus 10 via the serial port 11a. The physical layer unit 113b and link layer unit 114b function as a second serial interface which executes serial communication with an external device (the second hard disk drive (HDD #2) 12) via the serial port 11b.

The transport layer & command layer unit 116 executes reception of a command and write data from the host apparatus 10 and transmission of read data and a response to the host apparatus 10 via the first serial interface. Further, the transport layer & command layer unit 116 executes transmission of a command and write data to the second hard disk drive (HDD #2) 12 and reception of read data and a response from the second hard disk drive (HDD #2) 12 via the second serial interface.

The transport layer & command layer unit 116 includes a control unit 117, an arbiter 118, a FIFO buffer 119, an address decoder 120 and an address map storing unit 121.

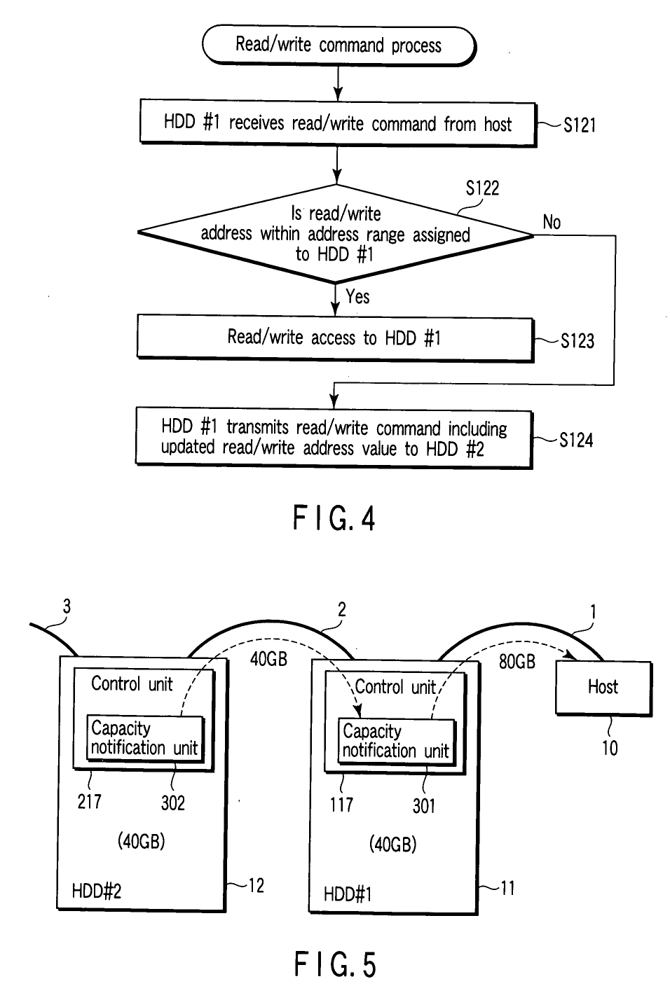

The control unit 117 controls the operation of the transport layer & command layer unit 116. The arbiter 118 arbitrates between the two serial interfaces. The FIFO buffer 119 is a buffer which temporarily stores a command, data, a response, etc. The address decoder 120 executes an address decoding process for determining, on the basis of address map information that is stored in the address map storing unit 121, whether an address value, which is included in an access command (read/write command) from the host apparatus 10, belongs to an address range assigned to the first hard disk drive (HDD #1) 11 (specifically, an address range assigned to a disk storage medium 132 of the data storage unit 112). The details of the address decoding process will be described later with reference to FIG. 3 and FIG. 4.

The data storage unit 112 includes a disk control unit 131 and the disk storage medium 132. The disk control unit 131 includes a hard disk controller (HDC), a microcomputer, and a read/write channel. The disk control unit 131 controls driving mechanisms, such as a head, an actuator and a spindle motor provided within the data storage unit 112, thereby executing data write on the disk storage medium 132 and data read from the disk storage medium 132.

The second hard disk drive (HDD #2) 12, like the first hard disk dive (HDD #1) 11, comprises an interface device 211 and a data storage unit 212.

The interface device 211 is an LSI which is mounted in the second hard disk drive (HDD #2) 12 in order to control serial communication via the two serial ports 12a and 12b. The interface device 211 is connected to the two serial ports 12a and 12b. The interface device 211 is also connected to the data storage unit 212 via an internal bus according to the parallel-ATA (P-ATA) standard.

The interface device 211 has a function of controlling the communication between the first hard disk drive (HDD #1) 11 that is the host of the second hard disk drive (HDD #2) 12, and the data storage unit 212, and a function of controlling the communication with the third hard disk drive.

The interface device 211 includes two physical layer units 213a and 213b, two link layer units 214a and 214b, and a transport layer & command layer unit 216.

The physical layer unit 213a and link layer unit 214a function as a first serial interface which executes serial communication with the first hard disk drive (HDD #1) 11 via the serial port 12a. The physical layer unit 213b and link layer unit 214b function as a second serial interface which executes serial communication with the third hard disk drive via the serial port 12b.

The transport layer & command layer unit 216 executes reception of a command and write data from the first hard disk drive (HDD #1) 11 and transmission of read data and a response to the first hard disk drive (HDD #1) 11 via the first serial interface. In addition, the transport layer & command layer unit 216 executes transmission of a command and write data to the third hard disk drive and reception of read data and a response from the third hard disk drive via the second serial interface.

The transport layer & command layer unit 216 includes a control unit 217, an arbiter 218, a FIFO buffer 219, an address decoder 220 and an address map storing unit 221.

The control unit 217 controls the operation of the transport layer & command layer unit 216. The arbiter 218 arbitrates between the two serial interfaces. The FIFO buffer 219 is a buffer which temporarily stores a command, data, a response, etc. The address decoder 220 executes an address decoding process for determining, on the basis of address map information that is stored in the address map storing unit 221, whether an address, which is included in an access command (read/write command) from the host apparatus 10, belongs to an address range assigned to the second hard disk drive (HDD #2) 12 (specifically, an address range assigned to a disk storage medium 232 of the data storage unit 212).

The data storage unit 212 includes a disk control unit 231 and the disk storage medium 232. The disk control unit 231 includes a hard disk controller (HDC), a microcomputer, and a read/write channel. The disk control unit 231 controls driving mechanisms, such as a head, an actuator and a spindle motor provided within the data storage unit 212, thereby executing data write on the disk storage medium 232 and data read-out from the disk storage medium 232.

Assuming that the number of daisy-chained hard disk drives is two, the operation of the system according to the embodiment will now be described.

To begin with, the operation of the system at the time of power-on is described.

At the time of power-on of the system, each of the hard disk drive (HDD #1) 11 and hard disk drive (HDD #2) 12 informs the host of completion of preparation for an initializing process. In the present system, the hard disk drive (HDD #2) 12 sends a status, which indicates the completion of preparation of the initializing process, to the hard disk drive (HDD #1) 11 that is the host for the hard disk drive (HDD #2) 12. When the preparation for the initializing process of both the hard disk drive (HDD #1) 11 and hard disk drive (HDD #2) 12 is completed, the hard disk drive (HDD #1) 11 sends a status, which indicates the completion of preparation of the initializing process, to the host apparatus 10.

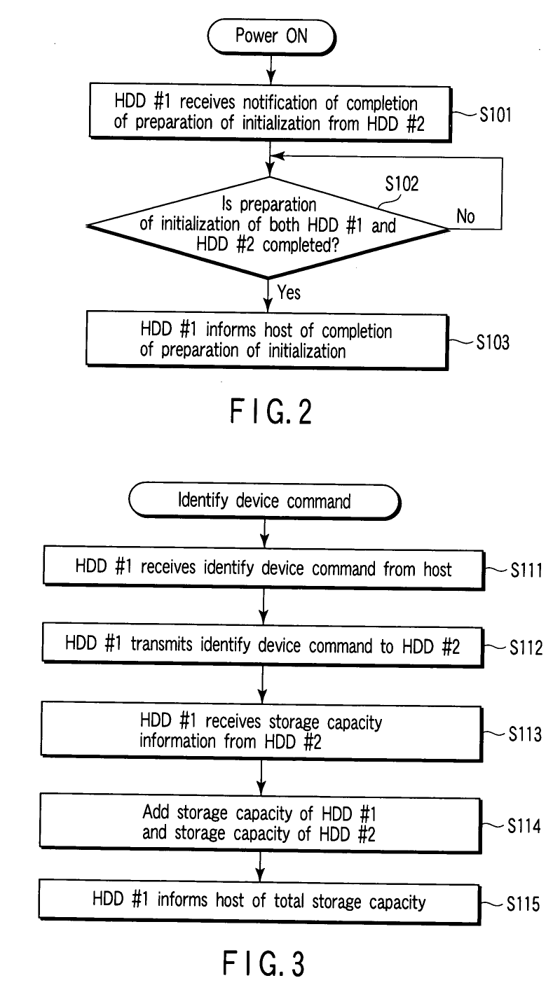

FIG. 2 is a flow chart illustrating the operation of the hard disk drive (HDD #1) 11 at the time of power-on.

The interface device 111 of the hard disk drive (HDD #1) 11 receives over the second serial bus 2 the status indicative of the completion of preparation for the initialization of the hard disk drive (HDD #2) 12, which is sent from the hard disk drive (HDD #2) 12 (block S101). Subsequently, the interface device 111 determines whether the preparation for the initializing process of both the hard disk drive (HDD #1) 11 and hard disk drive (HDD #2) 12 is completed (block S102). If the preparation for the initializing process of both the hard disk drive (HDD #1) 11 and hard disk drive (HDD #2) 12 is completed (YES in block S102), the interface device 111 sends the status indicative of the completion of preparation for the initializing process to the host apparatus 10 over the serial bus 1 (block S103).

In the case where the third hard disk drive is connected to the serial port 12b of the hard disk drive (HDD #2) 12, the interface device 211 of the hard disk drive (HDD #2) 12 executes the same process as the interface device 111. Specifically, when the preparation for the initializing process of both the hard disk drive (HDD #2) 12 and the third hard disk drive is completed, the interface device 211 sends a status, which indicates the completion of preparation of the initializing process, to the hard disk drive (HDD #1) 11.

Upon receiving the status which indicates the completion of preparation of the initializing process, the host apparatus 10 issues an IDENTIFY DEVICE command. The IDENTIFY DEVICE command is a command for confirming the storage capacity of the devices connected to the serial interface of the host apparatus 10. The hard disk drive (HDD #1) 11 issues the IDENTIFY DEVICE command, which is received from the host apparatus 10, to the disk control unit 131 within the data storage unit 112, and also issues, at the same time, the IDENTIFY DEVICE command to the hard disk drive (HDD #2) 12. This command transfer control is executed by the transport layer & command layer unit 116.

The hard disk drive (HDD #2) 12 processes the IDENTIFY DEVICE command that is issued from the hard disk drive (HDD #1) 11 as if it were issued from the host apparatus 10, and the hard disk drive (HDD #2) 12 returns to the hard disk drive (HDD #1) 11 a response indicative of the storage capacity of the hard disk drive (HDD #2) 12 (a maximum sector number of the disk storage medium 232).

The hard disk drive (HDD #1) 11 is capable of recognizing the storage capacity of the hard disk drive (HDD #2) 12 on the basis of the response from the hard disk drive (HDD #2) 12. The hard disk drive (HDD #1) 11 adds the storage capacity of the hard disk drive (HDD #1) 11 (e.g. a maximum sector number of the disk storage medium 132) to the storage capacity of the hard disk drive (HDD #2) 12, thereby calculating a total storage capacity. The hard disk drive (HDD #1) 11 returns a response indicative of the total storage capacity to the host apparatus 10.

As has been described above, in the present embodiment, a process of successively communicating the storage capacity information from the terminal-end device toward the device that is closest to the host is executed. In this case, each device informs an upstream-side device of a value which is calculated by adding the value of the storage capacity received from a downstream-side device to the value of its own storage capacity. Thereby, the host apparatus 10 is capable of recognizing the total storage capacity of all devices connected to the serial interface of the host apparatus 10 as the storage capacity of the hard disk drive (HDD #1) 11. The terminal-end device may be a device having two serial interfaces or an ordinary device having only one serial interface.

The hard disk drive (HDD #1) 11 creates address map information that is indicative of an address range which is included in the address range corresponding to the total storage capacity and is to be assigned to the hard disk drive (HDD #1) 11. When the hard disk drive (HDD #1) 11 receives an access command (read/write command) that is issued from the host apparatus 10, if an address value included in the access command hits the address range of the hard disk drive (HDD #1) 11, the hard disk drive (HDD #1) 11 issues the access command to the disk control unit 131 of the data storage unit 112. If the address value does not hit the address range of the hard disk drive (HDD #1) 11, the hard disk drive (HDD #1) 11 does not issue the access command to the disk control unit 131, but issues the access command to the hard disk drive (HDD #2) 12.

This decoding control of the access command is executed using the address decoder 120 and address map storing unit 121 which are provided in the transport layer & command layer unit 116.

Next, referring to a flow chart of FIG. 3, a description is given of an operation that is executed by the hard disk drive (HDD #1) 11 in response to the IDENTIFY DEVICE command.

The interface device 111 of the hard disk drive (HDD #1) 11 receives the IDENTIFY DEVICE command that is sent from the host apparatus 10 via the serial bus 1 (block S111). The control unit 117 of the interface device 111 transmits the received IDENTIFY DEVICE command to the disk control unit 131 of the data storage unit 112, causes the disk control unit 131 to execute a process that is associated with the IDENTIFY DEVICE command, and transmits the received IDENTIFY DEVICE command to the hard disk drive (HDD #2) 12 via the serial bus 2 (block S112).

The interface device 111 receives a response via the serial bus 2, which is sent from the hard disk drive (HDD #2) 12 (block S113). This response includes information indicative of the storage capacity of the hard disk drive (HDD #2) 12. The control unit 117 of the interface device 111 adds the storage capacity of the hard disk drive (HDD #1) 11 to the storage capacity of the hard disk drive (HDD #2) 12 which is informed from the hard disk drive (HDD #2) 12, thereby calculating a total storage capacity (block S114). In block S114, the control unit 117 of the interface device 111 also executes a process of creating, on the basis of the relationship between the total storage capacity and the storage capacity of the hard disk drive (HDD #1) 11, address map information indicative of an address range which is to be assigned to the hard disk drive (HDD #1) 11, that is, an address range which is to be assigned to the disk storage medium 132. The address map information defines which part of the address range corresponding to the total storage capacity is assigned to the hard disk drive (HDD #1) 11.

Subsequently, the control unit 117 sends information about the total storage capacity to the host apparatus 10 via the serial bus 1 as a response to the IDENTIFY DEVICE command (block S115).

In the case where the third hard disk drive is connected to the serial port 12b of the hard disk drive (HDD #2) 12, the interface device 211 of the hard disk drive (HDD #2) 12 executes the same process as the interface device 111. Specifically, when the interface device 211 receives the IDENTIFY DEVICE command from the hard disk drive (HDD #1) 11, the interface device 211 sends the received IDENTIFY DEVICE command to the disk control unit 231 of the data storage unit 212 and transmits the received IDENTIFY DEVICE command to the third hard disk drive via the serial bus 3. Then, the interface device 211 receives a response from the third hard disk drive. This response includes information indicative of the storage capacity of the third hard disk drive. The interface device 211 adds the storage capacity of the hard disk drive (HDD #2) 12 to the storage capacity which is informed from the third hard disk drive, thereby calculating a total storage capacity. The interface device 211 sends information of the total storage capacity to the hard disk drive (HDD #1) 11 as a response to the IDENTIFY DEVICE command. The interface device 211 also executes a process of creating, on the basis of the relationship between the calculated total storage capacity and the storage capacity of the hard disk drive (HDD #2) 12, address map information indicative of an address range which is to be assigned to the hard disk drive (HDD #2) 12, that is, an address range which is to be assigned to the disk storage medium 232.

If a fourth hard disk drive is connected to the downstream side of the third hard disk drive, the interface device provided in the third hard disk drive executes the same process as the interface device 111.

Thus, there are a case (case 1) in which the value of the storage capacity, which is informed from the hard disk drive (HDD #2) 12 to the hard disk drive (HDD #1) 11, indicates the storage capacity of the hard disk drive (HDD #2) 12 itself, and a case (case 2) in which the value of the storage capacity, which is informed from the hard disk drive (HDD #2) 12 to the hard disk drive (HDD #1) 11, indicates a storage capacity that is calculated by adding storage capacities of all downstream-side devices of the hard disk drive (HDD #2) 12 to the storage capacity of the hard disk drive (HDD #2) 12. The hard disk drive (HDD #1) 11, however, is not required to recognize distinction between case 1 and case 2. The hard disk drive (HDD #1) 11 recognizes that the storage capacity which is informed from the hard disk drive (HDD #2) 12 is the storage capacity of the external device that is connected to the serial port 11b of the hard disk drive (HDD #1) 11, and hard disk drive (HDD #1) 11 manages the address range that is to be assigned to the hard disk drive (HDD #1) 11, which is included in the total address range corresponding to the total storage capacity that includes the storage capacity informed from the hard disk drive (HDD #2) 12 and the storage capacity of the hard disk drive (HDD #1) 11.

The minimum system configuration of the system according to the present embodiment is a system configuration including only the host apparatus 10 and hard disk drive (HDD #1) 11. In this system configuration, too, an ordinary hard disk having only one serial port, which supports the S-ATA standard, may additionally be connected, as needed, to the serial port 11b.

Next, referring to a flow chart of FIG. 4, a description is given of an operation that is executed by the hard disk drive (HDD #1) 11 in response to an access command from the host apparatus 10.

The interface device 111 of the hard disk drive (HDD #1) 11 receives an access command (read/write command) that is transmitted from the host apparatus 10 via the serial bus 1 (block S121). On the basis of an address value included in the received access command and address map information stored in the address map storing unit 121, the interface device 111 determines whether the address value included in the received access command belongs to the address range of the hard disk drive (HDD #1) 11 (block S122). In block S122, the address decoder 120 compares the address value included in the received access command and the address map information and determines, based on the comparison result, whether the address value belongs to the address range that is designated by the address map information.

If the address value included in the received access command belongs to the address range of the hard disk drive (HDD #1) 11 (YES in block S122), the control unit 117 of the interface device 111 sends the received access command to the disk control unit 131, thus enabling the data storage unit 112 to execute a read/write process corresponding to the access command (block S123).

On the other hand, if the address value included in the received access command does not belong to the address range of the hard disk drive (HDD #1) 11 (NO in block S122), the control unit 117 of the interface device 111 sends the received access command to the hard disk drive (HDD #2) 12 via the serial bus 2 (block S124). In block S124, the control unit 117 executes, where necessary, a process of updating the address value included in the received access command, on the basis of the storage capacity of the hard disk drive (HDD #1) 11. In this case, the access command including the updated address value is sent to the hard disk drive (HDD #2) 12 via the serial bus 2. In the address updating process, for example, the storage capacity of the hard disk drive (HDD #1) 11 is subtracted from the address value included in the access command, and the subtraction result is calculated as the updated address value. If the access command is a write command that is accompanied with write data, the interface device 111 sends the write data, too, to the hard disk drive (HDD #2) 12 via the serial bus 2.

Upon receiving the access command, the hard disk drive (HDD #2) 12 executes a read/write process on the disk storage medium 232 in accordance with the access command. If the access command is a read command, the hard disk drive (HDD #2) 12 transmits read data, which is read out of the disk storage medium 232, to the hard disk drive (HDD #1) 11 via the serial bus 2. The hard disk drive (HDD #1) 11 transmits the read data, which is received from the hard disk drive (HDD #2) 12, to the host apparatus 10 via the serial bus 1.

In the case where the third hard disk drive is connected to the serial port 12b of the hard disk drive (HDD #2) 12, the interface device 211 of the hard disk drive (HDD #2) 12 executes the same process as the interface device 111. Specifically, when the interface device 211 receives the access command from the hard disk drive (HDD #1) 11, the interface device 211 determines, on the basis of an address value included in the received access command and address map information stored in the address map storing unit 221, whether the address value included in the access command belongs to the address range assigned to the hard disk drive (HDD #2) 12. If the address value falls within the assigned address range, the interface device 211 executes a read/write process. If the address value does not fall within the assigned address range, the interface device 211 transmits the access command to the third hard disk drive via the serial bus 3. In this case, the interface device 211, like the interface device 111, executes the address updating process. In the address updating process, the address value included in the access command is updated on the basis of the storage capacity of the hard disk drive (HDD #2) 12. For example, the interface device 211 executes a process of subtracting the storage capacity of the hard disk drive (HDD #2) 12 from the address value that is included in the access command. The access command including the updated address value is sent to the third hard disk drive via the serial bus 3.

By the above-described process, the host device 10 can handle the daisy-chained hard disk drives as a single storage device. Thus, without discriminating the respective daisy-chained hard disk drives, the host apparatus 10 can access the hard disk drives. Therefore, without losing the compatibility with the serial interface standard such as S-ATA, the host apparatus 10 can access plural devices via a single serial interface. In addition, the user can easily add a new hard disk drive, as needed. In this case, the new hard disk drive may not necessarily be a hard disk drive having the interface device of the present embodiment, and it may be an ordinary hard disk drive which supports the S-ATA standard. The user can connect an ordinary hard disk drive, which supports the S-ATA standard, to the serial port 11b of the hard disk drive (HDD #1) 11, thereby easily realizing extension of the storage capacity.

Commands, which are issued from the host apparatus 10, are classified into access commands (read command and write command) and other commands. If a command which is received from the host apparatus 10 is an access command, the interface device 111 executes the process which has been described with reference to FIG. 4. If the received command is a command other than the access command, the interface device 111 sends the received command to the data storage unit 112 and also transmits the received command to the hard disk drive (HDD #2) 12. If the received command is an access command, the interface device 211 of the hard disk drive (HDD #2) 12 similarly executes the process as described with reference to FIG. 4. If the received command is a command other than the access command, the interface device 211 sends the received command to the data storage unit 212 and also transmits the received command to the third hard disk drive.

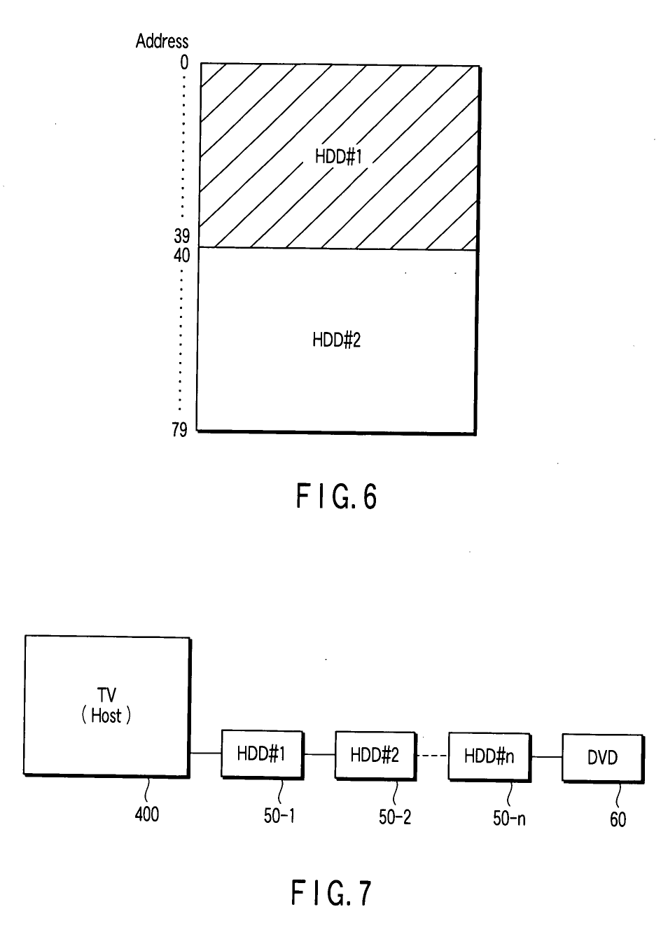

Next, referring to FIG. 5 and FIG. 6, a description is given of an example of the address map information in a case where the storage capacity of each of the hard disk drive (HDD #1) 11 and hard disk drive (HDD #2) 12 is 40 GB.

A capacity notification unit 302 is provided in the control unit 217 of the hard disk drive (HDD #2) 12. Upon receiving an IDENTIFY DEVICE command from the hard disk drive (HDD #1) 11, the capacity notification unit 302 informs the hard disk drive (HDD #1) 11 of the storage capacity (40 GB) of the hard disk drive (HDD #2) 12. The control unit 117 of the hard disk drive (HDD #1) 11 also includes a storage notification unit 301. The storage notification unit 301 calculates a total storage capacity (80 GB) by adding the storage capacity (40 GB) of the hard disk drive (HDD #1) 11 to the storage capacity (40 GB) which is informed from the hard disk drive (HDD #2) 12, and informs the host apparatus 10 of the total storage capacity (80 GB).

In this case, in the hard disk drive (HDD #1) 11, address map information, as shown in, for example, FIG. 6, is created on the basis of the relationship between the total storage capacity (80 GB) and the storage capacity (40 GB) of the hard disk drive (HDD #1) 11.

If the address value, which is designated by the access command from the host apparatus 10, belongs to the first half range of 40 GB of the address range of 80 GB, the read/write process of the hard disk drive (HDD #1) 11 is executed.

On the other hand, if the address value, which is designated by the access command from the host apparatus 10, belongs to the second half range of 40 GB of the address range of 80 GB, the access command from the host apparatus 10 is sent from the hard disk drive (HDD #1) 11 to the hard disk drive (HDD #2) 12. In this case, the hard disk drive (HDD #1) 11 executes the process of updating the address value by subtracting 40 GB from the address value that is designated by the access command.

Alternatively, the address range of the hard disk drive (HDD #1) 11 may be assigned to the second half range of 40 GB of the address range corresponding to the total storage capacity (80 GB).

In this case, if the address value, which is designated by the access command from the host apparatus 10, belongs to the second half range of 40 GB of the address range of 80 GB, the read/write process of the hard disk drive (HDD #1) 11 is executed. The interface device 111 updates the address value by subtracting the storage capacity (40 GB), which is informed from the hard disk drive (HDD #2) 12, from the address value designated by the access command, and transmits the access command including the updated address value to the data storage unit 112. On the other hand, if the address value, which is designated by the access command from the host apparatus 10, belongs to the first half range of 40 GB of the address range of 80 GB, the access command from the host apparatus 10 is sent from the hard disk drive (HDD #1) 11 to the hard disk drive (HDD #2) 12. In this case, there is no need to execute the address updating process.

In the present embodiment, when the IDENTIFY DEVICE command is received from the host apparatus 10, the hard disk drive (HDD #1) 11 issues the IDENTIFY DEVICE command to the hard disk drive (HDD #2) 12. Alternatively, when the system is powered on, the hard disk drive (HDD #1) 11 may automatically issue the IDENTIFY DEVICE command to the hard disk drive (HDD #2) 12. In this case, when the IDENTIFY DEVICE command is received from the host apparatus 10, the hard disk drive (HDD #1) 11 can immediately inform the host apparatus 10 of the total storage capacity.

In this embodiment, the hard disk drive is exemplified as a storage device having two serial ports. Alternatively, the storage device may be a DVD drive, a memory card, etc.

FIG. 7 show another example of the system configuration of the embodiment.

The system shown in FIG. 7 comprises a TV receiver 400, a plurality of hard disk drives 50-1 to 50-n and a DVD drive 60. The hard disk drives 50-1 to 50-n and the DVD drive 60 are daisy-chained by some serial buses. The TV receiver 400 can access the hard disk drives 50-1 to 50-n and DVD drive 60 via a single serial interface which is provided in the TV receiver 400.

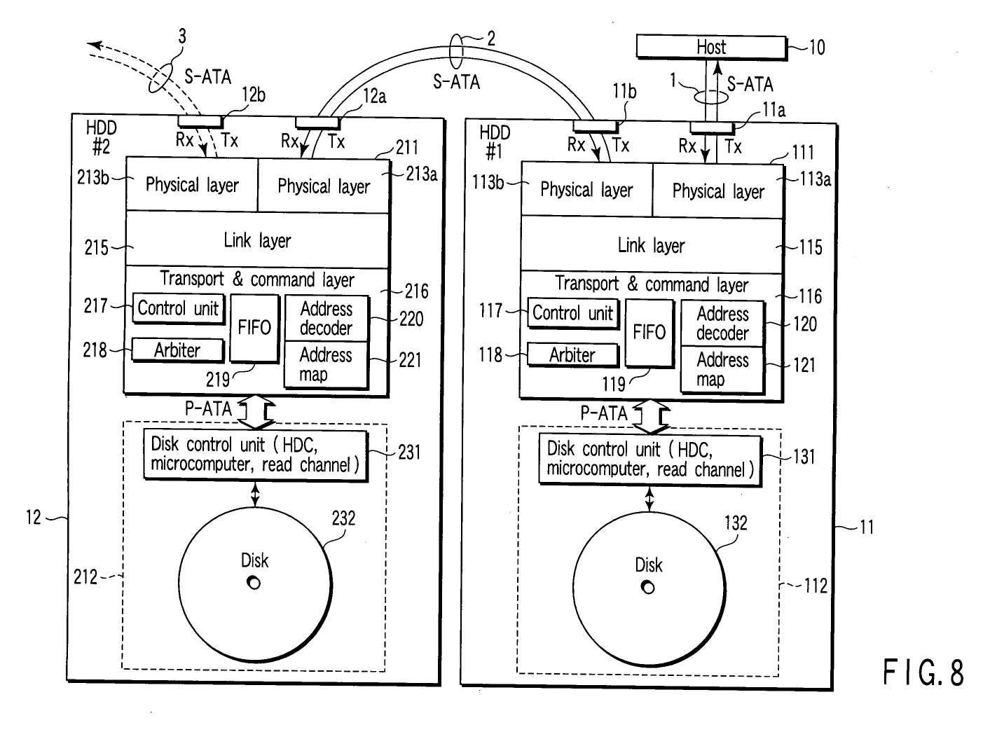

FIG. 8 shows another example of the interface device according to the embodiment.

As is shown in FIG. 8, in each of the interface devices 111 and 211, a link layer unit is shared by two serial ports. Specifically, in the interface device 111, two serial interfaces corresponding to the serial ports 11a and 11b are realized by two physical layer units 113a and 113b and a single link layer unit 115. In the interface device 211, two serial interfaces corresponding to the serial ports 12a and 12b are realized by two physical layer units 213a and 213b and a single link layer unit 215.

By sharing the single link layer unit between the two serial ports, the circuit scale of the interface device can be reduced. In order to reduce the number of link layer units to one, a control, which is different from a control for a state machine defined by the S-ATA standard, is necessary. It is possible, however, to adopt such a design that the interface device may appear, from the serial port side, to operate as if according to the S-ATA standard. For example, such a technique may be adopted that while one of the two serial ports is being used for data transmission, the reception of a primitive (i.e. a minimum data transfer unit) of a transfer request from the other serial port is awaited.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An interface device which is configured to be mountable in a storage device and controls communication between the storage device and a host apparatus, comprising:
a first serial interface which executes communication with the host apparatus;
a second serial interface which executes communication with an external device;
a storage capacity notification unit which calculates a total storage capacity by adding a storage capacity of the storage device to a storage capacity of the external device, which is informed from the external device via the second serial interface, and informs the host apparatus of the total storage capacity via the first serial interface;
an address map storing unit which stores address map information indicative of an address range which is to be assigned to the storage device, the address map information being calculated based on a relationship between the total storage capacity and the storage capacity of the storage device;
an address decoder which determines, in a case where an access command that is sent from the host apparatus is received by the first serial interface, whether an address value included in the access command belongs to the address range based on the address value included in the access command and the address map information; and
a control unit which sends the access command to a data storage unit within the storage device in a case where the address value belongs to the address range, and transmits the access command to the external device via the second serial interface in a case where the address value does not belong to the address range.

2. The interface device according to claim 1, wherein in a case where the address value does not belong to the address range, the control unit updates the address value based on the storage capacity of the data storage unit and transmits the access command including the updated address value to the external device via the second serial interface.

3. The interface device according to claim 1, further comprising means for sending, in a case where a command other than the access command, which is transmitted from the host apparatus, is received by the first serial interface, the received command to the data storage unit, and also transmitting the received command to the external device via the second serial interface.

4. The interface device according to claim 1, wherein the first serial interface is connected to the host apparatus via a first serial bus, and the second serial interface is connected to the external device via a second serial bus.

5. A storage device which stores data in a storage medium, comprising:
a first serial interface which executes communication with a host apparatus;
a second serial interface which executes communication with an external device;
a storage capacity notification unit which calculates a total storage capacity by adding a storage capacity of the storage medium to a storage capacity of the external device, which is informed from the external device via the second serial interface, and informs the host apparatus of the total storage capacity via the first serial interface;
an address map storing unit which stores address map information indicative of an address range which is to be assigned to the storage device, the address map information being calculated based on a relationship between the total storage capacity and the storage capacity of the storage medium;
an address decoder which determines, in a case where an access command that is sent from the host apparatus is received by the first serial interface, whether an address value included in the access command belongs to the address range based on the address value included in the access command and the address map information; and
a control unit which executes read/write access to the storage medium in accordance with the access command in a case where the address value belongs to the address range, and transmits the access command to the external device via the second serial interface in a case where the address value does not belong to the address range.

6. The storage device according to claim 5, wherein in a case where the address value does not belong to the address range, the control unit updates the address value based on the storage capacity of the storage medium and transmits the access command including the updated address value to the external device via the second serial interface.

7. The storage device according to claim 5, further comprising means for executing, in a case where a command other than the access command, which is transmitted from the host apparatus, is received by the first serial interface, a process corresponding to the received command, and also transmitting the received command to the external device via the second serial interface.

8. A control method which controls an operation of a storage device which stores data in a storage medium, the storage device being connected to a host apparatus via a first serial bus and connected to an external device via a second serial bus, comprising:
calculating a total storage capacity by adding a storage capacity of the storage medium to a storage capacity of the external device, which is informed from the external device via the second serial bus, and informing the host apparatus of the total storage capacity via the first serial bus;
creating address map information indicative of an address range which is to be assigned to the storage device, based on a relationship between the total storage capacity and the storage capacity of the storage medium;
determining whether an address value included in an access command, which is sent from the host apparatus via the first serial bus, belongs to the address range based on the address value included in the access command and the address map information;
executing read/write access to the storage medium in accordance with the access command in a case where the address value belongs to the address range; and
transmitting the access command to the external device via the second serial bus in a case where the address value does not belong to the address range.

9. The control method according to claim 8, wherein said transmitting the access command to the external device includes updating the address value based on the storage capacity of the storage medium and transmitting the access command including the updated address value to the external device via the second serial bus.

10. The control method according to claim 8, further comprising means for transmitting, in a case where a command other than the access command is received from the host apparatus via the first serial bus, the received command to the external device via the second serial bus.

11. A system including a host apparatus, a first storage device connected to the host apparatus via a first serial bus, and a second storage device connected to the first storage device via a second serial bus, the first storage device comprising:
means for calculating a total storage capacity by adding a storage capacity of the first storage device to a storage capacity of the second storage device, which is informed from the second storage device via the second serial bus, and informing the host apparatus of the total storage capacity via the first serial bus;
means for storing address map information indicative of an address range which is to be assigned to the first storage device, the address map information being calculated based on a relationship between the total storage capacity and the storage capacity of the first storage device;
means for determining whether an address value included in an access command, which is sent from the host apparatus via the first serial bus, belongs to the address range based on the address value included in the access command and the address map information; and
means for executing read/write access to a storage medium within the first storage device in accordance with the access command in a case where the address value belongs to the address range, and transmitting the access command to the second storage device via the second serial bus in a case where the address value does not belong to the address range.
